(19) United States
(12) Patent Application Publication
(10) Pub. No.: US 2021/0108920 A1
(43) Pub. Date: Apr. 15, 2021

(54) MAGNETIC SENSOR CALIBRATION METHODS, CONTROL TERMINALS, AND MOVABLE PLATFORMS

(71) Applicant: SZ DJI TECHNOLOGY CO., LTD., Shenzhen (CN)

(72) Inventors: Yongkang TAO, Shenzhen (CN); Zhenzhou LAI, Shenzhen (CN)

(73) Assignee: SZ DJI TECHNOLOGY CO., LTD., Shenzhen (CN)

(21) Appl. No.: 17/129,915

(22) Filed: Dec. 22, 2020

Related U.S. Application Data
(63) Continuation of application No. PCT/CN2018/097270, filed on Jul. 26, 2018.

(51) Int. Cl. G01C 17/38; G01C 17/28

(52) U.S. Cl. CPC G01C 17/38; G01C 17/28

(57) ABSTRACT

The present disclosure provides a magnetic sensor calibration method, and a control terminal and a movable platform that implement this method. The method includes: after detecting that a magnetic sensor calibration condition is triggered, obtaining multiple sets of magnetic field intensity output by a magnetic sensor on a movable platform during rotation of the movable platform; determining a calibration coefficient of the magnetic sensor based on a reference magnetic field intensity and the multiple sets of magnetic field intensity; and calibrating a magnetic field intensity output by the magnetic sensor based on the calibration coefficient of the magnetic sensor. Therefore, the magnetic sensor can be calibrated in time even if the movable platform is moving, so that the magnetic sensor can output accurate magnetic field intensities and a moving direction of the movable platform can be accurately determined, thereby ensuring movement security of the movable platform.

### RELATED APPLICATIONS

The present patent document is a continuation of PCT Application Serial No. PCT/CN2018/097270, filed on Jul. 26, 2018, designating the United States and published in Chinese, the content of which is incorporated herein by reference in its entirety.

### BACKGROUND

### 1. Technical Field

The present disclosure relates to the field of electronics technology, and in particular, to magnetic sensor calibration methods, control terminals, and movable platforms.

### 2. Background

The compass is a sensor that measures the magnetic field. It can detect directions through the three-axis components of the sensitive geomagnetic field. Therefore, an unmanned aerial vehicle (UAV) can be equipped with a compass to detect the current heading of the UAV and accurately control its flight to ensure flight safety. However, the magnetic field has impact on the compass, and the compass needs to be calibrated to obtain the correct heading of the UAV.

Generally, the compass is usually calibrated manually. For example, a user holds the UAV on the ground and rotates it in the horizontal direction to obtain the three-axis magnetic field intensities of the compass, and rotates it in the vertical direction to obtain the three-axis magnetic field intensities of the compass, then calibrates the compass in the UAV based on the three-axis magnetic field intensities in the horizontal direction and the vertical direction.

However, the UAV generally flies in the air. In the air, the UAV may receive interference from magnetic interference sources such as high-voltage cables and many steel-reinforced buildings, which affects the detection of the heading. Since the UAV cannot be calibrated by using the foregoing method in the air, and accidents may occur.

### BRIEF SUMMARY

The present disclosure provides magnetic sensor calibration methods, control terminals, and movable platform so that the magnetic sensor can be calibrated in time and can output an accurate magnetic field intensity, and the heading of the UAV can be accurately determined, thereby ensuring the flight safety of the movable platform.

In accordance with a first aspect of the present disclosure, there is provided a magnetic sensor calibration method for a movable platform, which comprises: obtaining multiple sets of magnetic field intensity output by a magnetic sensor on the movable platform during rotation of the movable platform which includes at least horizontal rotation after detecting that a magnetic sensor calibration condition is triggered; determining a calibration coefficient of the magnetic sensor based on a reference intensity of the calibrated magnetic field (hereinafter the “reference magnetic field intensity) and the multiple sets of magnetic field intensity, wherein the reference magnetic field intensity is a magnetic field intensity output by the magnetic sensor after a first calibration or a last calibration; and calibrating a magnetic field intensity output by the magnetic sensor based on the calibration coefficient of the magnetic sensor.

In accordance with a second aspect of the present disclosure, there is provided a movable platform, which comprises a magnetic sensor configured to output a magnetic field intensity; and a processor configured to calibrate the magnetic sensor; wherein the processor is further configured to: obtain multiple sets of magnetic field intensity output by the magnetic sensor during rotation of the movable platform, wherein the rotation includes at least horizontal rotation after detecting that a calibration condition of the magnetic sensor is triggered; determine a calibration coefficient of the magnetic sensor based on a reference magnetic field intensity and the multiple sets of magnetic field intensity, wherein the reference magnetic field intensity is a magnetic field intensity output by the magnetic sensor after a first calibration or a last calibration; and calibrate the magnetic field intensity output by the magnetic sensor based on the calibration coefficient of the magnetic sensor.

Therefore, the technology of the present disclosure may calibrate the magnetic sensor in time, even if the movable platforms are moving, the magnetic sensors may be calibrated, so that the magnetic sensors may output accurate magnetic field intensities, and therefore accurately determine the moving direction of the movable platforms, ensuring mobile security for the mobile platforms.

### BRIEF DESCRIPTION OF THE DRAWINGS

To describe the technical solutions in the exemplary embodiments of the present disclosure or in the prior art more clearly, the following briefly introduces the accompanying drawings required for describing the examples or the prior art. Apparently, the accompanying drawings in the following description show some examples of the present invention, and a person of ordinary skill in the art may still derive other drawings from these accompanying drawings without creative efforts.

FIG. 1 is a schematic architecture diagram of an unmanned aircraft system according to some exemplary embodiments of the present disclosure;

FIG. 2 is a flowchart of a magnetic sensor calibration method according to some exemplary embodiments of the present disclosure;

FIG. 3 is a schematic structural diagram of a movable platform according to some exemplary embodiments of the present disclosure;

FIG. 4 is a schematic structural diagram of a control terminal according to some exemplary embodiments of the present disclosure; and

FIG. 5 is a schematic structural diagram of a magnetic sensor calibration system according to some exemplary embodiments of the present disclosure.

### DETAILED DESCRIPTION

In order to make the objectives, technical solutions and advantages of the embodiments of the present disclosure clearer, the following clearly and completely describes the technical solutions in the embodiments of the present disclosure with reference to the accompanying drawings in the embodiments of the present disclosure. Apparently, the described embodiments are some rather than all of the embodiments of the present disclosure. All other embodiments obtained by a person of ordinary skill in the art based on the embodiments of the present disclosure without creative efforts shall fall within the protection scope of the present disclosure.

It should be noted that when a component is referred to being “fixed to” another component, it may be directly on the another component or a central component may also exist. When a component is considered to be “connected to” another component, it may be directly connected to the another component or a central component may also exist.

Unless otherwise defined, all technical and scientific terms used herein have the same meaning as commonly understood by those skilled in the technical field of the present disclosure. The terms used in the specification of the present disclosure herein are only for the purpose of describing specific embodiments, and are not intended to limit the present disclosure. The term “and/or” used herein includes any and all combinations of one or more related listed items.

The following describes in detail some implementations of the present disclosure with reference to the accompanying drawings. If no conflict occurs, the following embodiments and features in the embodiments may be mutually combined.

Embodiments of the present invention provide a magnetic sensor calibration method, a control terminal, and a movable platform. A magnetic sensor is a device that can sense the magnetic field intensity, such as a compass, a magnetic field sensor (also known as a magnetometer), or a position sensor, and the like. The movable platform may be, for example, a UAV, an unmanned ship, an unmanned vehicle, or a robot, and so on. The UAV may be, for example, a rotorcraft, such as a rotorcraft driven by multiple propulsion devices through the air, and the embodiments of the present disclosure are not limited thereto.

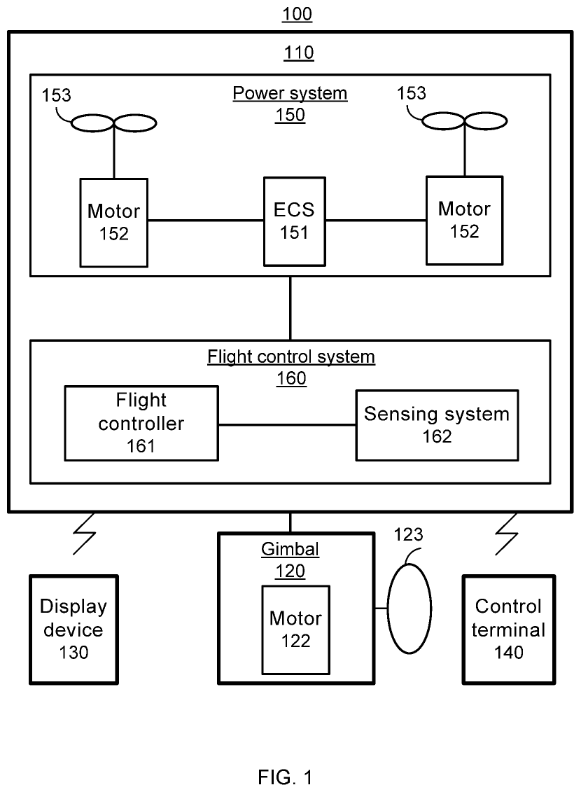

FIG. 1 is a schematic architecture diagram of an unmanned aircraft system according to some exemplary embodiments of the present disclosure. In the embodiments, a UAV is used as an example for description.

An unmanned aircraft system 100 may include a UAV 110, a display device 130, and a control terminal 140. The UAV 110 may include a power system 150, a flight control system 160, a frame, and a gimbal 120 carried on the frame. The UAV 110 may communicate with the control terminal 140 and the display device 130 through wireless.

The frame may include a fuselage and a landing gear (also known as a landing skid). The fuselage may include a central frame and one or more arms connected to the central frame, where the one or more arms may extend radially from the central frame. The landing gear is connected to the fuselage, and is configured to support the UAV 110 when landing.

The power system 150 may include one or more electronic speed controllers (ESCs for short) 151, one or more propellers 153, and one or more motors 152 corresponding to the one or more propellers 153, where the motor 152 is connected between the ESC 151 and the propeller 153, the motor 152 and the propeller 153 may be arranged on the arm of the UAV 110; the ESC 151 is configured to receive a driving signal generated by the flight control system 160 and provide a driving current to the motor 152 based on the driving signal to control the speed of the motor 152; the motor 152 is configured to drive the propeller to rotate, so as to provide power for the UAV 110, where the power enables the UAV 110 to move with one or more degrees of freedom of movement. In some embodiments, the UAV 110 may rotate around one or more rotation axes. For example, the rotation axes may include a roll axis (Roll), a yaw axis (Yaw), and a pitch axis (Pitch). It can be appreciated that the motor 152 may be a DC motor, or may be an AC motor. In addition, the motor 152 may be a brushless motor, or may be a brushed motor.

The flight control system 160 may include a flight controller 161 and a sensing system 162. The sensing system 162 is configured to measure attitude information of the UAV, that is, position information and status information of the UAV 110 in space, such as the three-dimensional position, three-dimensional angle, three-dimensional velocity, three-dimensional acceleration, and three-dimensional angular velocity. The sensing system 162 may include, for example, at least one of sensors such as a gyroscope, an ultrasonic sensor, an electronic compass, an inertial measurement unit (IMU), a vision sensor, a global navigation satellite system, and a barometer. For example, the global navigation satellite system may be a global positioning system (GPS). The flight controller 161 is configured to control the flight of the UAV 110, for example, control the flight of the UAV 110 based on the attitude information measured by the sensing system 162. It can be appreciated that the flight controller 161 may control the UAV 110 according to pre-programed instructions, or may control the UAV 110 by responding to one or more control instructions from the control terminal 140.

The gimbal 120 may include a motor 122. The gimbal 120 is configured to carry a photographing device 123. The flight controller 161 may control the movement of the gimbal 120 through the motor 122. In another exemplary embodiment, the gimbal 120 may further include a controller, configured to control the movement of the gimbal 120 by controlling the motor 122. It can be appreciated that the gimbal 120 may be independent of the UAV 110 or may be a part of the UAV 110. It can be appreciated that the motor 122 may be a DC motor, or may be an AC motor. In addition, the motor 122 may be a brushless motor, or may be a brushed motor. It can be further appreciated that the gimbal 120 may be located on the top of the UAV 110, or may be located at the bottom of the UAV 110.

The photographing device 123 may be, for example, a device for capturing images, such as a camera or a video camera. The photographing device 123 may communicate with the flight controller and take images under the control of the flight controller. The photographing device 123 of this embodiment includes at least a photosensitive element, and the photosensitive element is, for example, a complementary metal oxide semiconductor (CMOS) sensor or a charge-coupled device (CCD) sensor. It can be appreciated that the photographing device 123 may be directly fixed on the UAV 110, so the gimbal 120 may be omitted.

The display device 130 may be located at a ground end of the unmanned aircraft system 100, may communicate with the UAV 110 in a wireless manner, and may be configured to display the attitude information of the UAV 110. In addition, the display device 130 may display an image taken by the photographing device. It can be appreciated that the display device 130 may be an independent device, or may be integrated in the control terminal 140.

The control terminal 140 may be located at the ground end of the unmanned aircraft system 100, may communicate with the UAV 110 through wireless, and may be configured to control the UAV 110 remotely.

In addition, the UAV 110 may also be equipped with a speaker (not shown in the figure), and the speaker is configured to play an audio file. The speaker may be directly fixed on the UAV 110, or may be mounted on the gimbal 120.

It should be understood that the names of the components of the unmanned aircraft system are only for identification purposes and should not be understood as a limitation to the embodiments of the present disclosure. The following describes the solution of the present disclosure by using an example that the movable platform as a UAV and the magnetic sensor as a compass.

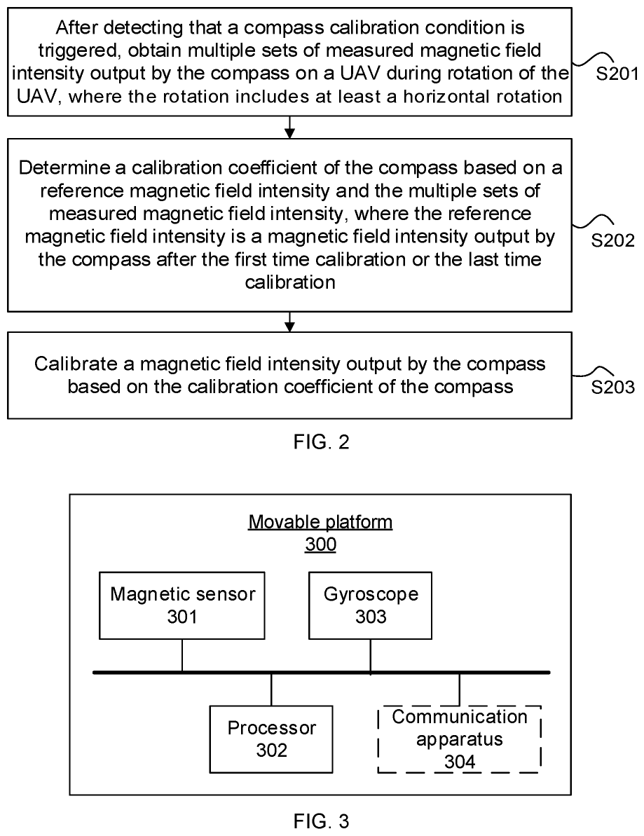

FIG. 2 is a flowchart of a magnetic sensor calibration method according to some exemplary embodiments of the present disclosure. As shown in FIG. 2, the method of this embodiment may be, for example, applied to a UAV to calibrate a compass on the UAV, such as a processor of the UAV. The method may include the following steps.

S201: after detecting that a compass calibration condition is triggered, obtain multiple sets of measured intensities of magnetic field (hereinafter the multiple sets of measured magnetic field intensities or multiple sets of magnetic intensities) output by the compass on the UAV during the rotation of the UAV, and the rotation includes at least horizontal rotation.

In some exemplary embodiments, after it is detected that the compass calibration condition is triggered, the UAV may measure the magnetic field intensity output by the compass on the UAV to obtain multiple sets of measured magnetic field intensities during the rotation of the UAV are obtained, where the rotation may be performed in a predetermined manner, such as rotating the UAV in a predetermined plane. For example, the rotation of the UAV may include at least a horizontal rotation of the UAV. Here, the horizontal rotation may be, for example, a rotation of the UAV in a horizontal plane, i.e., a rotation around the yaw axis, or placing the UAV in a phorizontal position (like when the UAV is navigating horizontally) and rotating the UAV in a horizontal plane, or placing the UAV in a vertical position perpendicular to the horizontal position and rotating the UAV in the horizontal plane. In some embodiments, a rotation of the UAV may further include vertical rotation, and the vertical rotation may be, for example, the rotation of the UAV in a vertical plane, i.e., a rotation around the pitch axis. The present disclosure does not intend to limit what is included in the rotation of the UAV. It should be noted that this exemplary embodiment is not limited to that the UAV only performs horizontal rotation. Multiple sets of magnetic field intensity output by the compass can be obtained, provided that there is a horizontal rotation component when the UAV rotates.

For example, the UAV may obtain the current magnetic field intensities measured by and output from the compass along the yaw axis, pitch axis, and roll axis of the UAV with a present frequency. Since the UAV is rotating, the measured and/or current magnetic field intensities in each set may differ from that of another set.

In some exemplary embodiments, the detecting that a compass calibration condition is triggered may be, for example, detecting that a time period to calibrate the compass is reached, which means detecting that the compass calibration condition is triggered. For example, if the compass calibration time period is 1 minute, the compass calibration condition is triggered every one minute.

In some exemplary embodiments, the detecting that a compass calibration condition is triggered may be, for example, detecting that the UAV receives a compass calibration instruction sent by the control terminal of the UAV. The compass calibration instruction is used to instruct the UAV to perform compass calibration, the control terminal is configured to control the UAV, and the control terminal may communicate with the UAV through wireless (such as Wi-Fi or a 3G, 4G, or 5G mobile communication network). In this embodiment, the user may control, by operating the control terminal, the UAV to perform compass calibration. When the user wants to control the UAV to perform compass calibration, the user inputs a compass calibration operation to the control terminal. After detecting the compass calibration operation of the user, the control terminal determines the compass calibration instruction based on the compass calibration operation, and sends the compass calibration instruction to the UAV. Correspondingly, the UAV receives the compass calibration instruction sent by the control terminal. The control terminal includes one or more of a remote control, a smartphone, a tablet computer, a laptop computer, and a wearable device. The compass calibration operation may be input by the user by operating an interactive device of the control terminal. The interactive device may be, for example, one or more of a touch screen, a keyboard, a joystick, and an impeller of the control terminal. In addition, the touchscreen may display all flight parameters of the UAV, and may also display images taken by the UAV.

In some exemplary embodiments, the detecting that a compass calibration condition is triggered may be, for example, detecting that a difference between a modulus of the magnetic field intensity output by the compass and a predefined modulus is greater than a preset difference, which means detecting that the compass calibration condition is triggered, where if the modulus of the magnetic field intensity output by the compass is greater than the predefined modulus, the difference between the modulus of the magnetic field intensity output by the compass and the predefined modulus is a value obtained by subtracting the predefined modulus from the modulus of the magnetic field intensity output by the compass; if the modulus of the magnetic field intensity output by the compass is less than the predefined modulus, the difference between the modulus of the magnetic field intensity output by the compass and the predefined modulus is a value obtained by subtracting the modulus of the magnetic field intensity output by the compass from the predefine modulus.

In some exemplary embodiments, the detecting that a compass calibration condition is triggered may be, for example, detecting that the flight parameters of the UAV meet a preset compass calibration condition, which means detecting that the compass calibration condition is triggered.

In some exemplary embodiments, after it is detected that the compass calibration condition is triggered, the magnetic field intensity output by the compass during rotation of the UAV is obtained, where the rotation includes at least horizontal rotation. In addition, in some exemplary embodiments, a number of rotations of the UAV is obtained by using a gyroscope on the UAV. When the number of rotations is greater than or equal to a preset number of rotations, obtaining a magnetic field intensity output by the compass during the rotation of the UAV stops. In some exemplary embodiments, multiple sets of magnetic field intensity can be obtained from the start to the end of the process of obtaining magnetic field intensities. If the number of rotations is less than the preset count, the obtained magnetic field intensity is not accurate enough to determine a calibration coefficient of the compass, S202 and S203 are not performed, and the compass calibration process ends in some exemplary embodiments.

In some exemplary embodiments, after detecting that the compass calibration condition is triggered, it is determined whether the UAV performs rotation that includes horizontal rotation. If so, multiple sets of magnetic field intensity output by the compass during the rotation of the UAV are obtained; if not, the UAV is controlled to perform rotation that includes horizontal rotation. For example, the UAV in some exemplary embodiments may automatically control the UAV to perform rotation that includes horizontal rotation.

In some exemplary embodiments, when it is detected that the compass calibration condition is triggered (for example, the UAV receives a compass calibration instruction sent by the control terminal), the user may perform a rotation control operation on the control terminal of the UAV. For example, the user inputs a rotation control operation by operating the interaction device of the control terminal. The control terminal detects the rotation control operation of the user, and then sends a rotation control instruction to the UAV based on the rotation control operation. The UAV receives the rotation control instruction from the control terminal, performs rotation that includes horizontal rotation according to the rotation control instruction, and then obtains multiple sets of magnetic field intensity output by the compass during the rotation of the UAV. For example, before the control terminal sends the rotation control instruction to the UAV, if the UAV is flying in the air, the control terminal also displays rotation control information, where the rotation control information is used to instruct the user to operate the control terminal to control the UAV to perform rotation that includes at least horizontal rotation. The user obtains the rotation control information through the control terminal, and then inputs the rotation control operation to the control terminal, so that the control terminal sends the rotation control instruction to the UAV.

In some embodiments, after it is detected that the compass calibration condition is triggered (for example, the UAV receives the compass calibration instruction sent by the control terminal), if the UAV stops on an obstacle surface, the control terminal may display rotation prompt information, which may be used to prompt the user to hold the UAV and rotate it in a horizontal plane, and the rotation includes at least horizontal rotation. The user may obtain the rotation prompt information through the control terminal, and then hold the UAV and performs rotation that includes at least horizontal rotation. Then the UAV may rotate under the action of the user. In this embodiment, multiple sets of magnetic field intensity output by the compass during the rotation of the UAV can be obtained.

In some other exemplary embodiments, if the UAV does not perform rotation that includes at least horizontal rotation within a preset time after detecting that the compass calibration condition may be triggered, multiple sets of magnetic field intensity that are used to determine the calibration coefficient may not be able to be obtained in this embodiment. In this case, the compass calibration may process ends without performing S201 to S203 in some exemplary embodiments.

S202: determine a calibration coefficient of the compass based on a reference magnetic field intensity and the multiple sets of magnetic field intensity, where the reference magnetic field intensity may be a magnetic field intensity output by the compass after the first calibration or the last calibration.

S203: calibrate a magnetic field intensity output by the compass based on the calibration coefficient of the compass.

In some exemplary embodiments, after multiple sets of magnetic field intensity are obtained, the calibration coefficient of the compass may be determined based on the reference magnetic field intensity and the multiple sets of magnetic field intensity. Then, the magnetic field intensity output by the compass may be calibrated based on the calibration coefficient of the compass, to obtain a more accurate magnetic field intensity.

In some exemplary embodiments, the reference magnetic field intensity may be the magnetic field intensity output by the compass after the first calibration. The first calibration may be the calibration performed on the compass in the UAV by the user on the ground. For this calibration process, reference may be made to the related description of the prior art, and details are not described herein. In this embodiment, after the first calibration of the compass in the UAV, each subsequent time the compass in the UAV is calibrated, that is, each time it is detected that the compass calibration condition is triggered, multiple sets of magnetic field intensity output by the compass during the rotation of the UAV are obtained, the calibration coefficient of the compass may be determined based on the reference magnetic field intensity (which is the magnetic field intensity output by the compass after the first calibration) and the multiple sets of magnetic field intensity, and the magnetic field intensity output by the compass is calibrated based on the calibration coefficient of the compass.

In some other exemplary embodiments, the reference magnetic field intensity is the magnetic field intensity output by the compass after the last calibration, and the last calibration may be a calibration previous to a current calibration performed on the compass in the UAV by the user. In this embodiment, during a current calibration of the compass in the UAV, a calibration coefficient is determined based on a magnetic field intensity output by the compass from the previous calibration and multiple sets of magnetic field intensity obtained currently, and then a magnetic field intensity output by the compass is calibrated based on the calibration coefficient of the compass. During a next calibration of the compass in the UAV, a calibration coefficient is determined based on a magnetic field intensity output by the compass from the current calibration and multiple sets of magnetic field intensity obtained, and then a magnetic field intensity output by the compass is calibrated based on the calibration coefficient of the compass. In this embodiment, after the first calibration of the compass in the UAV, each subsequent time the compass in the UAV is calibrated, that is, each time it is detected that the compass calibration condition is triggered, multiple sets of magnetic field intensity output by the compass during the rotation of the UAV are obtained, the calibration coefficient of the compass is determined based on the magnetic field intensity output by the compass after the last calibration, and the magnetic field intensity output by the compass is calibrated based on the calibration coefficient of the compass. For example, during a flight, the UAV may first calibrate a magnetic field intensity output by the compass based on a magnetic field intensity output by the compass after the first calibration, and then the UAV can calibrate a magnetic field intensity output by the compass based on a magnetic field intensity output from the last calibration.

In some other exemplary embodiments, the reference magnetic field intensity may not be limited to the magnetic field intensity output by the compass after the last calibration, and may be a magnetic field intensity output by the compass from at least one previous calibration before the current calibration. For example, during the (M+1)th, (M+2)th, and (M+N)th calibration of the magnetic field intensity, all the calibrations may be based on a magnetic field intensity output by the compass after the Mth calibration, where N is an integer greater than or equal to 1. That is, during a calibration of the UAV, S201 to S203 are performed, where a reference magnetic field intensity during this calibration is the magnetic field intensity output by the compass after the first calibration; during multiple subsequent calibrations of the UAV, S201 to S203 are also performed, where a difference is that a reference magnetic field intensity during the calibration is a magnetic field intensity output after S201 to S203 are performed.

According to the magnetic sensor calibration method provided by this exemplary embodiment, after it is detected that the compass calibration condition is triggered, the multiple sets of magnetic field intensity output by the compass on the UAV during the rotation of the UAV are obtained, where the rotation includes at least horizontal rotation. The calibration coefficient of the compass may be determined based on the reference magnetic field intensity and the multiple sets of magnetic field intensity, where the reference magnetic field intensity is the magnetic field intensity output by the compass after the first calibration or the last calibration; and the magnetic field intensity output by the compass is calibrated based on the calibration coefficient of the compass. Therefore, in this embodiment, the compass can be calibrated in time even if the UAV is flying in the air, so that the compass can output an accurate magnetic field intensity, and the heading of the UAV can be accurately determined, thereby ensuring the flight safety of the UAV.

In some exemplary embodiments, the magnetic field intensity includes a pitch-axis magnetic field intensity and a yaw-axis magnetic field intensity, that is, each of the multiple sets of magnetic field intensity includes: a pitch-axis magnetic field intensity and a yaw-axis magnetic field intensity. The reference magnetic field intensity includes at least a reference pitch-axis magnetic field intensity and a reference yaw-axis magnetic field intensity. Correspondingly, calibrating the magnetic field intensity output by the compass may include calibrating the pitch-axis magnetic field intensity and the yaw-axis magnetic field intensity output by the compass.

For example, the calibration coefficient includes: a magnetic field intensity gain, a pitch-axis magnetic field intensity offset, and a yaw-axis magnetic field intensity offset.

For example, the magnetic field intensity further includes: a roll-axis magnetic field intensity. That is, each of the multiple sets of magnetic field intensity includes: a pitch-axis magnetic field intensity, a yaw-axis magnetic field intensity, and a roll-axis magnetic field intensity. The reference magnetic field intensity includes a reference pitch-axis magnetic field intensity, a reference yaw-axis magnetic field intensity, and a reference roll-axis magnetic field intensity. Correspondingly, calibrating the magnetic field intensity output by the compass may include calibrating the pitch-axis magnetic field intensity, the yaw-axis magnetic field intensity, and the roll-axis magnetic field intensity output by the compass. For example, the calibration coefficient includes: a magnetic field intensity gain, a pitch-axis magnetic field intensity offset, a yaw-axis magnetic field intensity offset, and a roll-axis magnetic field intensity offset.

In some exemplary embodiments, an exemplary implementation of S202 is: determining the calibration coefficient of the compass based on that each axis magnetic field intensity in each set of the multiple sets of magnetic field intensity and a corresponding axis magnetic field intensity in the reference magnetic field intensity meet preset criteria, and that a sum of squares of all axes magnetic field intensities in each set of magnetic field intensities is equal to a preset modulus, where the reference magnetic field intensity includes: a reference pitch-axis magnetic field intensity, a reference roll-axis magnetic field intensity, and a reference yaw-axis magnetic field intensity.

For example, the determining of the calibration coefficient of the compass may be based on at least two conditions: for each set of measured magnetic field intensities: (1) the measured magnetic field intensity along the roll axis (“the measured roll-axis magnetic field intensity”) may meet a present criterion with the reference magnetic field intensity along the roll axis (“the reference roll-axis magnetic field intensity”); the measured magnetic field intensity along the pitch axis (“the measured pitch-axis magnetic field intensity”) may meet a present criterion with the reference magnetic field intensity along the pitch axis (“the reference pitch-axis magnetic field intensity”); and the measured magnetic field intensity along the yaw axis (“the measured yaw-axis magnetic field intensity”) may meet a present criterion with the reference magnetic field intensity along the yaw axis (“the reference yaw-axis magnetic field intensity”); and (2) a sum of squares of the measured magnetic field intensities along the yaw axis, pitch axis, and roll axis (i.e., the measured yaw-axis magnetic field intensity, the measured pitch-axis magnetic field intensity, and the measured roll-axis magnetic field intensity) is equal to the preset modulus.

For example, that each axis magnetic field intensity in each set of magnetic field intensities and a corresponding axis magnetic field intensity in the reference magnetic field intensity meet a preset relationship includes that each axis magnetic field intensity in each set of magnetic field intensities and a corresponding axis magnetic field intensity in the reference magnetic field intensity are in a linear relationship. For example, the preset criterion between the measured pitch-axis magnetic field intensity and the reference pitch-axis magnetic field intensity is a linear relationship; the preset criterion between the measured yaw-axis magnetic field intensity and the reference yaw-axis magnetic field intensity is a linear relationship; and the preset criterion between the measured roll-axis magnetic field intensity and the reference roll-axis magnetic field intensity is a linear relationship.

The following description describes S202 by taking an example that the magnetic field intensity includes a pitch-axis magnetic field intensity and a yaw-axis magnetic field intensity. If the magnetic field intensity includes the pitch-axis magnetic field intensity and the yaw-axis magnetic field intensity, the magnetic field intensity may be called a two-axis magnetic field intensity. A specific implementation process of S202 may be:

substituting each set of two-axis magnetic field intensity of the multiple sets of two-axis magnetic field intensities into the formula

$$\{ \begin{matrix}{m}_{xi} = S * {m}_{x} + {b}_{x} \\ {m}_{yi} = S * {m}_{y} + {b}_{y} \\ {m}_{xi}^{2} + {m}_{yi}^{2} + {r}_{1}^{2}\end{matrix} ,$$

and then performing linearize processing and least-squares fitting processing on the formula to obtain the calibration coefficient of the compass.

mₓ is the reference pitch-axis magnetic field intensity in the reference magnetic field intensity, m_{y} is the reference yaw-axis magnetic field intensity in the reference magnetic field intensity, mₓᵢ is a pitch-axis magnetic field intensity in the ith set of the multiple sets of two-axis magnetic field intensities, m_{yi} is a yaw-axis magnetic field intensity in the ith set of the multiple sets of two-axis magnetic field intensities, i is greater than or equal to 1, S is the magnetic field intensity gain, bₓ is the pitch-axis magnetic field intensity offset, b_{y} is the yaw-axis magnetic field intensity offset, r₁ is a specified two-axis output modulus of the compass, and mₓ, m_{y}, and r₁ are known values (predetermined values).

The calibration coefficient of the compass obtained in this embodiment includes: the magnetic field intensity gain S, the pitch-axis magnetic field intensity offset bₓ, and the yaw-axis magnetic field intensity offset b_{y}. Correspondingly, when S203 is performed, the two-axis magnetic field intensity output by the compass is calibrated based on the calibration coefficient of the compass. The specific implementation process is: according to the following formula:

$$\{ \begin{matrix}{m}_{x}^{″} = S * {m}_{x}^{′} + {b}_{x} \\ {m}_{y}^{″} = S * {m}_{y}^{′} + {b}_{y}\end{matrix} ,$$

a calibrated pitch-axis magnetic field intensity and a calibrated yaw-axis magnetic field intensity output by the compass can be obtained.

S is the magnetic field intensity gain in the obtained calibration coefficient, bₓ is the pitch-axis magnetic field intensity offset in the obtained calibration coefficient, b_{y} is the yaw-axis magnetic field intensity offset in the obtained calibration coefficient, mₓ′ is the pitch-axis magnetic field intensity output by the compass, m_{y}′ is the yaw-axis magnetic field intensity output by the compass, mₓ″ is the calibrated pitch-axis magnetic field intensity output by the compass, and m_{y}″ is the calibrated yaw-axis magnetic field intensity output by the compass.

For example, in some exemplary embodiments, after the multiple sets of two-axis magnetic field intensities are obtained, the number of sets of two-axis magnetic field intensities distributed in each spatial quadrant of the four spatial quadrants around the magnetic sensor (and/or UAV) is determined based on the multiple sets of two-axis magnetic field intensity; and when the number of sets of two-axis magnetic field intensities in each spatial quadrant is greater than a first preset number of sets, the specific implementation process of S202 is performed. The four spatial quadrants include: spatial quadrants of positive and negative pitch axes and positive and negative yaw axes, that is, a spatial quadrant of the positive pitch axis and the positive yaw axis, a spatial quadrant of the negative pitch axis and the positive yaw axis, a spatial quadrant of the positive pitch axis and the negative yaw axis, and a spatial quadrant of the negative pitch axis and the negative yaw axis. These spatial quadrants may be formed by, for example, the pitch axis and the yaw axis when the UAV stops on the horizontal plane. For example, if the number of sets of two-axis magnetic field intensities in at least one spatial quadrant is less than or equal to the first preset number of sets, S202 and S203 are not performed, and the compass calibration process ends in some exemplary embodiments.

The following description describes S202 by taking an example that the magnetic field intensity includes a pitch-axis magnetic field intensity, a yaw-axis magnetic field intensity, and a roll-axis magnetic field intensity. If the magnetic field intensity includes the pitch-axis magnetic field intensity, the yaw-axis magnetic field intensity, and the roll-axis magnetic field intensity, the magnetic field intensity may be called a three-axis magnetic field intensity. A specific implementation process of S202 may be:

substituting each set of three-axis magnetic field intensities of multiple sets of three-axis magnetic field intensities into the following formula,

$$\{ \begin{matrix}{m}_{xi} = S * {m}_{x} + {b}_{x} \\ {m}_{yi} = S * {m}_{y} + {b}_{y} \\ \begin{matrix}{m}_{zi} = S * {m}_{z} + {b}_{z} \\ {m}_{xi}^{2} + {m}_{yi}^{2} + {m}_{zi}^{2} = {r}_{1}^{2}\end{matrix}\end{matrix}$$

and then performing linearization processing and least-squares fitting processing on the formula to obtain the calibration coefficient of the compass.

mₓ is the reference pitch-axis magnetic field intensity in the reference magnetic field intensity, m_{y} is the reference yaw-axis magnetic field intensity in the reference magnetic field intensity, m_{z} is the reference roll-axis magnetic field intensity in the reference magnetic field intensity, mₓᵢ is a pitch-axis magnetic field intensity in the ith set of the multiple sets of three-axis magnetic field intensities, m_{yi} is a yaw-axis magnetic field intensity in the ith set of the multiple sets of three-axis magnetic field intensities, m_{zi} is a roll-axis magnetic field intensity in the ith set of the multiple sets of three-axis magnetic field intensities, i is greater than or equal to 1, S is the magnetic field intensity gain, bₓ is the pitch-axis magnetic field intensity offset, b_{y} is the yaw-axis magnetic field intensity offset, b_{z} is the roll-axis magnetic field intensity offset, r₂ is a specified three-axis output modulus of the compass, and mₓ, m_{y}, m_{z}, and r₂ are known values.

The calibration coefficient of the compass obtained in some exemplary embodiments includes: the magnetic field intensity gain S, the pitch-axis magnetic field intensity offset bₓ, the yaw-axis magnetic field intensity offset b_{y}, and the roll-axis magnetic field intensity offset b_{z}. Correspondingly, when S203 is performed, the three-axis magnetic field intensity output by the compass is calibrated based on the calibration coefficient of the compass. The specific implementation process is: according to the following formula:

$$\{ \begin{matrix}{m}_{x}^{″} = S * {m}_{x}^{′} + {b}_{x} \\ {m}_{y}^{″} = S * {m}_{y}^{′} + {b}_{y} \\ {m}_{z}^{″} = S * {m}_{z}^{′} + {b}_{z}\end{matrix} ,$$

a calibrated pitch-axis magnetic field intensity, a calibrated yaw-axis magnetic field intensity, and a calibrated roll-axis magnetic field intensity output by the compass can be obtained.

S is the magnetic field intensity gain in the obtained calibration coefficient, bₓ is the pitch-axis magnetic field intensity offset in the obtained calibration coefficient, b_{y} is the yaw-axis magnetic field intensity offset in the obtained calibration coefficient, b_{z} is the roll-axis magnetic field intensity offset in the obtained calibration coefficient, mₓ′ is the pitch-axis magnetic field intensity output by the compass, m_{y}′ is the yaw-axis magnetic field intensity output by the compass, m_{z}′ is the roll-axis magnetic field intensity output by the compass, mₓ″ is the calibrated pitch-axis magnetic field intensity output by the compass, m_{y}″ is the calibrated yaw-axis magnetic field intensity output by the compass, and m_{z}″ is the calibrated roll-axis magnetic field intensity output by the compass.

For example, in some exemplary embodiments, after the multiple sets of three-axis magnetic field intensities are obtained, the number of sets of three-axis magnetic field intensities distributed in each of eight spatial quadrants around the magnetic sensor (and/or UAV) may be determined based on the multiple sets of three-axis magnetic field intensity; and when the number of sets of three-axis magnetic field intensities in each spatial quadrant is greater than a second preset number of sets, the specific implementation process of S202 is performed. The eight spatial quadrants include: spatial quadrants of positive and negative pitch axes, positive and negative yaw axes, and positive and negative roll axes, that is, a spatial quadrant of the positive pitch axis, the positive yaw axis, and the positive roll axis, a spatial quadrant of the positive pitch axis, the positive yaw axis, and the negative roll axis, a spatial quadrant of the positive pitch axis, the negative yaw axis, and the positive roll axis, a spatial quadrant of the positive pitch axis, the negative yaw axis, and the negative roll axis, a spatial quadrant of the negative pitch axis, the positive yaw axis, and the positive roll axis, a spatial quadrant of the negative pitch axis, the positive yaw axis, and the negative roll axis, a spatial quadrant of the negative pitch axis, the negative yaw axis, and the positive roll axis, and a spatial quadrant of the negative pitch axis, the negative yaw axis, and the negative roll axis. These spatial quadrants may be formed by, for example, the pitch axis, the yaw axis, and the roll axis when the UAV stops on the horizontal plane. For example, if the number of sets of three-axis magnetic field intensities in at least one spatial quadrant is less than or equal to the second preset number of sets, S202 and S203 are not performed, and the compass calibration process ends in this embodiment.

In some embodiments, after S203 is performed, calibration completion information may be sent to the control terminal of the UAV, where the calibration completion information may be used to indicate that the calibration process of the compass is completed. Correspondingly, the control terminal receives the calibration completion information sent by the UAV, and displays the calibration completion information, so that the user knows that the calibration process of the compass is completed.

In conclusion, in some exemplary embodiments of the present disclosure, after it is detected that the compass calibration condition is triggered, multiple sets of magnetic field intensity output by the compass during the rotation of the UAV are obtained, where the rotation includes at least horizontal rotation; the calibration coefficient of the compass may be determined based on a magnetic field intensity output by the compass after a previous calibration (the first or last calibration) and the multiple sets of magnetic field intensity; and the magnetic field intensity output by the compass is calibrated based on the calibration coefficient of the compass. Therefore, in some exemplary embodiments, the compass can be calibrated in time even if the UAV is flying in the air, so that the compass can output an accurate magnetic field intensity, and the heading of the UAV can be accurately determined, thereby ensuring the flight safety of the UAV. Moreover, through the foregoing solutions, the two-axis magnetic field intensity output by the compass can be calibrated, and the three-axis magnetic field intensity output by the compass can also be calibrated.

An embodiment of the present disclosure further provides a computer storage medium, where the computer storage medium stores program instructions, and when a program is executed by a processor, some or all of the steps of the magnetic sensor calibration method in the foregoing embodiments may be performed.

One of ordinary skill in the art also would understand at the time of filing of this disclosure that the computer storage medium in the foregoing embodiments of the present disclosure is one form of non-transitory computer-readable storage media that can retrieve stored information even after having been power cycled, for example, ROM, EPROM, EEPROM, hard disk drives, flash memory, optical discs, magnetic tapes, etc.

FIG. 3 is a schematic structural diagram of a movable platform according to an exemplary embodiment of the present disclosure. As shown in FIG. 3, the movable platform 300 of this embodiment may include: a magnetic sensor 301 and a processor 302. The magnetic sensor 301 and the processor 302 are communicatively connected through a bus. For example, the movable platform 300 of this exemplary embodiment may further include a gyroscope 303, where the gyroscope 303 and the processor 302 may be communicatively connected through a bus. For example, the movable platform 300 of this exemplary embodiment may further include a communication apparatus 304, where the communication apparatus 304 and the processor 302 may be communicatively connected through a bus. The processor 302 may be a central processing unit (CPU), or the processor 302 may be a general processor, a digital signal processor (DSP), an application specific integrated circuit (ASIC), a field-programmable gate array (FPGA) or other programmable logic devices, a discrete gate or transistor logic device, a discrete hardware component, or the like. The general processor may be a microprocessor or the processor may also be any conventional processor or the like.

The magnetic sensor 301 may be configured to output a magnetic field intensity.

The processor 302 may be configured to: after detecting that a calibration condition of the magnetic sensor 301 may be triggered, obtain multiple sets of magnetic field intensity output by the magnetic sensor 301 on the movable platform during rotation of the movable platform, where the rotation includes at least horizontal rotation; determine a calibration coefficient of the magnetic sensor 301 based on a reference magnetic field intensity and the multiple sets of magnetic field intensity, where the reference magnetic field intensity is a magnetic field intensity output by the magnetic sensor 301 after the first calibration or the last calibration; and calibrate a magnetic field intensity output by the magnetic sensor 301 based on the calibration coefficient of the magnetic sensor 301.

In some exemplary embodiments, when detecting that the calibration condition of the magnetic sensor is triggered, the processor 302 is specifically configured to:

detect that flight parameters of the movable platform meet a preset magnetic sensor calibration condition; or

detect that the communications apparatus 304 receives a magnetic sensor calibration instruction sent by a control terminal of the movable platform, where the magnetic sensor calibration instruction is determined by the control terminal based on a detected magnetic sensor calibration operation of a user; or

detect that a time period to calibrate the magnetic sensor is reached; or

detect that a difference between a modulus of the magnetic field intensity output by the magnetic sensor 301 and a predefined modulus is greater than a preset difference.

For example, each set of magnetic field intensities includes a pitch-axis magnetic field intensity and a yaw-axis magnetic field intensity.

For example, the calibration coefficient includes: a magnetic field intensity gain, a pitch-axis magnetic field intensity offset, and a yaw-axis magnetic field intensity offset.

For example, each set of magnetic field intensities further includes: a roll-axis magnetic field intensity.

For example, the calibration coefficient further includes: a roll-axis magnetic field intensity.

In some exemplary embodiments, the processor 302 is specifically configured to: determine the calibration coefficient of the magnetic sensor 301 based on that each axis magnetic field intensity in each set of the multiple sets of magnetic field intensity and a corresponding axis magnetic field intensity in the reference magnetic field intensity meet a preset criterion, and that a sum of squares of various axes magnetic field intensities in each set of magnetic field intensities is equal to a preset modulus. The reference magnetic field intensity includes a reference pitch-axis magnetic field intensity, a reference roll-axis magnetic field, and a reference yaw-axis magnetic field intensity.

For example, that each axis magnetic field intensity in each set of magnetic field intensities and a corresponding axis magnetic field intensity in the reference magnetic field intensity meet a preset criterion includes that each axis magnetic field intensity in each set of magnetic field intensities and a corresponding axis magnetic field intensity in the reference magnetic field intensity are in a linear relationship.

In some exemplary embodiments, the processor 302 is specifically configured to: determine the number of sets of magnetic field intensity distributed in each spatial quadrant of four spatial quadrants around the magnetic sensor (and/or UAV) based on the multiple sets of magnetic field intensity; and when the number of sets of magnetic field intensity in each spatial quadrant is greater than a first preset number of sets, determine the calibration coefficient of the magnetic sensor 301 based on the reference magnetic field intensity and the multiple sets of magnetic field intensity. The four spatial quadrants may include: spatial quadrants of positive and negative pitch axes, and positive and negative yaw axes.

In some exemplary embodiments, the processor 302 is specifically configured to: determine the number of sets of magnetic field intensity distributed in each of eight spatial quadrants around the magnetic sensor (and/or UAV) based on the multiple sets of magnetic field intensity; and when the number of sets of magnetic field intensity in each spatial quadrant is greater than a second preset number of sets, determine the calibration coefficient of the magnetic sensor 301 based on the reference magnetic field intensity and the multiple sets of magnetic field intensity. The eight spatial quadrants may include: spatial quadrants of positive and negative roll axes, positive and negative pitch axes, and positive and negative yaw axes.

In some exemplary embodiments, the gyroscope 303 is configured to obtain a number of rotations of the movable platform.

The processor 302 is configured to: when the number of rotations is greater than or equal to a preset number of rotations, stop obtaining a magnetic field intensity output by the magnetic sensor 301 during the rotation of the movable platform.

In some exemplary embodiments, the communication apparatus 304 may be configured to: after the processor 302 determines the calibration coefficient of the magnetic sensor 301 based on the reference magnetic field intensity and N sets of magnetic field intensity, send calibration completion information to the control terminal of the movable platform, where the calibration completion information is used to indicate that the calibration process of the compass is completed.

In some exemplary embodiments, the communication apparatus 304 may be configured to: before the processor 302 obtains the multiple sets of magnetic field intensity output by the magnetic sensor 301 on the movable platform during the rotation of the movable platform, receive a rotation control instruction sent by the control terminal of the movable platform. The processor 302 is further configured to control rotation of the movable platform according to the rotation control instruction, where the rotation includes at least horizontal rotation.

In some exemplary embodiments, the processor 302 may be further configured to: after the calibration condition of the magnetic sensor is triggered, control rotation of the movable platform before obtaining the multiple sets of magnetic field intensity output by the magnetic sensor 301 on the movable platform during the rotation of the movable platform, where the rotation includes at least horizontal rotation.

In some exemplary embodiments, the movable platform 300 of this embodiment may further include a memory (not shown in the figure), where the memory is configured to store code for executing the magnetic sensor calibration method, and when the code is called, the solutions in this embodiment are implemented.

One of ordinary skill in the art also would understand at the time of filing of this disclosure that the memory in the exemplary embodiments of the present disclosure is one form of non-transitory computer-readable storage media.

The movable platform of this embodiment may be configured to implement the technical solutions of the UAV in the foregoing method embodiments of the present disclosure. The implementation principles and technical effects are similar, and details are not repeated herein.

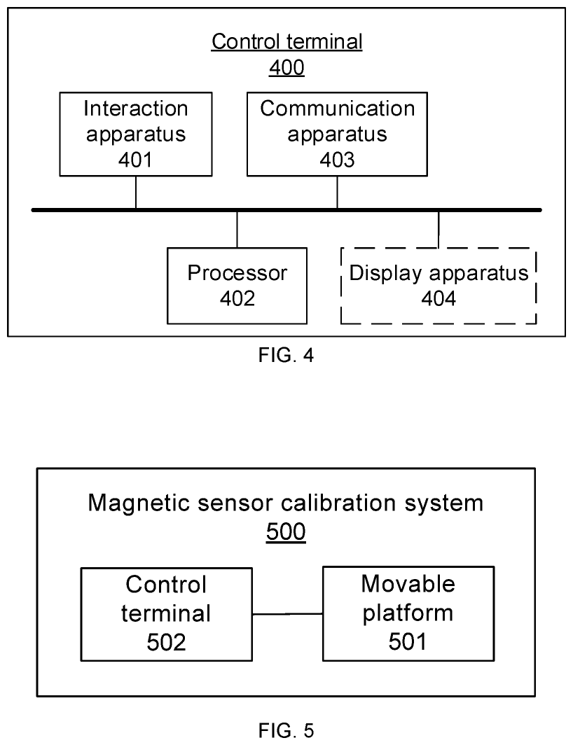

FIG. 4 is a schematic structural diagram of a control terminal according to some exemplary embodiments of the present disclosure. As shown in FIG. 4, the control terminal 400 of this embodiment may include: an interaction apparatus 401, a processor 402, and a communication apparatus 403. The interaction apparatus 401, the processor 402, and the communication apparatus 403 are communicatively connected through a bus. For example, the control terminal 400 of this exemplary embodiment may further include a display apparatus 404, and the display apparatus 404 may be communicatively connected to the foregoing components through a bus. The processor 402 may be a CPU, or may be a general processor, a DSP, an ASIC, an FPGA or another programmable logic device, a discrete gate or transistor logic device, a discrete hardware component, or the like. The general processor may be a microprocessor, or the processor may also be any conventional processor.

The interaction apparatus 401 may be configured to detect a magnetic sensor calibration operation of a user.

The processor 402 may be configured to determine a magnetic sensor calibration instruction based on the detected magnetic sensor calibration operation.

The communications apparatus 403 may be configured to send the magnetic sensor calibration instruction to a movable platform, so that the movable platform calibrates the magnetic sensor according to the magnetic sensor calibration instruction.

In some exemplary embodiments, the communication apparatus 403 may be further configured to: after sending the magnetic sensor calibration instruction to the movable platform, receive calibration completion information sent by the movable platform, where the calibration completion information is used to indicate that the calibration process of the compass is completed.

The display apparatus 404 may be configured to display the calibration completion information.

In some exemplary embodiments, the display apparatus 404 may be configured to: after the communications apparatus 403 sends the magnetic sensor calibration instruction to the movable platform, if the movable platform stops on an obstacle surface, display rotation prompt information, where the rotation prompt information is used to prompt the user to hold the movable platform and rotate it, and the rotation includes at least horizontal rotation.

In some exemplary embodiments, the display apparatus 404 may be configured to: after the communication apparatus 403 sends the magnetic sensor calibration instruction to the movable platform, if the movable platform is flying in the air, display rotation prompt information, where the rotation prompt information is used to prompt the user to operate the control terminal to control rotation of the movable platform, and the rotation includes at least horizontal rotation. The interaction apparatus 401 is further configured to detect a rotation control operation of the user. The communication apparatus 403 is further configured to send a rotation control instruction to the movable platform based on the rotation control operation of the user, to control the rotation of the movable platform.

In some exemplary embodiments, the control terminal 400 of this embodiment may further include a memory (not shown in the figure), where the memory is configured to store code for executing the magnetic sensor calibration method, and when the code is called, the solutions in this embodiment are implemented.

The control terminal of this embodiment may be configured to implement the technical solutions of the control terminal in the foregoing method embodiments of the present disclosure. The implementation principles and technical effects are similar, and details are not repeated herein.

FIG. 5 is a schematic structural diagram of a magnetic sensor calibration system according to some exemplary embodiments of the present disclosure. As shown in FIG. 5, the magnetic sensor calibration system 500 of this embodiment may include: a movable platform 501 and a control terminal 502. The movable platform 501 may use the structure in the embodiment shown in FIG. 3, and correspondingly, may implement the technical solutions of the UAV in the foregoing method embodiments. The implementation principles and technical effects are similar, and details are not repeated herein. The control terminal 502 may use the structure in the embodiment shown in FIG. 4, and correspondingly, may implement the technical solutions of the control terminal in the foregoing method embodiments. The implementation principles and technical effects are similar, and details are not repeated herein.

Ones of ordinary skill in the art may understand that all or some of the steps of the method embodiments may be implemented by a program instructing relevant hardware. The program may be stored in a computer readable storage medium. When the program runs, the steps of the method embodiments are performed. The foregoing storage medium includes: any medium that can store program code, such as a read-only memory (ROM), a random access memory (RAM), a magnetic disk, or an optical disc.

Finally, it should be noted that the foregoing embodiments are intended only to illustrate and not to limit the technical solutions of the present disclosure. Although the present disclosure has been described in detail with reference to the foregoing embodiments, those of ordinary skill in the art should understand that they can still modify the technical solutions described in the foregoing embodiments, or equivalently replace some or all of the technical features therein. These modifications or replacements do not make the essence of the corresponding technical solutions deviate from the scope of the technical solutions of the embodiments of the present disclosure.

1. A method for calibrating a magnetic sensor of a movable platform, comprising:
obtaining multiple sets of measured intensity of a magnetic field output by a magnetic sensor on a movable platform during rotation of the movable platform after detecting that a magnetic sensor calibration condition is triggered, wherein the rotation includes at least a rotation in a horizontal plane;
determining a calibration coefficient of the magnetic sensor based on a reference magnetic field intensity of the magnetic sensor and the multiple sets of measured intensity, wherein the reference magnetic field intensity is an intensity of the magnetic field output by the magnetic sensor after a first time calibration or a last time calibration; and
calibrating the intensity of the magnetic field output by the magnetic sensor based on the calibration coefficient of the magnetic sensor.

2. The method according to claim 1, wherein the detecting that the magnetic sensor calibration condition is triggered includes at least one of:
detecting that at least one flight parameter of the movable platform meets a preset magnetic sensor calibration condition;
detecting that the movable platform receives a magnetic sensor calibration instruction from a control terminal of the movable platform, wherein the magnetic sensor calibration instruction is determined by the control terminal based on a detected magnetic sensor calibration operation of a user;
detecting that a time period to calibrate the magnetic sensor is reached; or detecting that a difference between a modulus of the intensity of the magnetic field output by the magnetic sensor and a predefined modulus is greater than a preset difference.

3. The method according to claim 1, wherein each set of the multiple sets of measured intensity includes a pitch-axis magnetic field intensity and a yaw-axis magnetic field intensity; and
the calibration coefficient includes a magnetic intensity gain, a pitch-axis magnetic field intensity offset, and yaw-axis magnetic field intensity offset.

4. The method of claim 3, wherein
each set of the multiple sets of measured intensity further includes a roll-axis magnetic field intensity; and
the calibration coefficient also includes a roll-axis magnetic field intensity offset.

5. The method according to claim 1, wherein the reference magnetic field intensity includes a reference pitch-axis magnetic field intensity, a reference yaw-axis magnetic field intensity, and a reference roll-axis magnetic field intensity;
each set of the multiple sets of measured intensity includes a pitch-axis magnetic field intensity, a yaw-axis magnetic field intensity, and a roll-axis magnetic field intensity; and
the determining of the calibration coefficient of the magnetic sensor based on the reference magnetic field intensity and the multiple sets of measured intensities includes:
determining the calibration coefficient of the magnetic sensor based on
that for each set of the multiple set of measured intensity, the pitch-axis magnetic field intensity, the yaw-axis magnetic field intensity, and the roll-axis magnetic field intensity respectively meet a corresponding preset criterion with the reference pitch-axis magnetic field intensity, the reference yaw-axis magnetic field intensity, and the reference roll-axis magnetic field intensity , and
a sum of squares of the pitch-axis magnetic field intensity, the yaw-axis magnetic field intensity, and the roll-axis magnetic field intensity is equal to a preset modulus.

6. The method according to claim 5, wherein the preset criterion between the pitch-axis magnetic field intensity and the reference pitch-axis magnetic field intensity is a linear relationship;
the preset criterion between the yaw-axis magnetic field intensity and the reference yaw-axis magnetic field intensity is a linear relationship; and
the preset criterion between the roll-axis magnetic field intensity and the reference roll-axis magnetic field intensity is a linear relationship.

7. The method according to claim 1, further comprising:
obtaining a number of rotations of the movable platform by a gyroscope on the movable platform; and
when the number of rotations is greater than or equal to a preset number of rotations, stopping obtaining the measured intensity of the magnetic field output by the magnetic sensor during the rotation of the movable platform.

8. The method according to claim 7, further comprising, after the determining of the calibration coefficient of the magnetic sensor based on the reference magnetic field intensity and the multiple sets of measured intensity:
sending calibration completion information to a control terminal of the movable platform, wherein the calibration completion information indicates that a calibration process of the magnetic sensor is completed.

9. The method according to claim 1, further comprising, before the obtaining of the multiple sets of measured intensity output by the magnetic sensor on the movable platform during the rotation of the movable platform :
receiving a rotation control instruction sent by a control terminal of the movable platform; and
controlling the rotation of the movable platform according to the rotation control instruction.

10. The method according to claim 1, further comprising, before the obtaining of the multiple sets of measured intensity output by the magnetic sensor on the movable platform during the rotation of the movable platform:
controlling the rotation of the movable platform after the magnetic sensor calibration condition is triggered.

11. A movable platform, comprising:
a magnetic sensor configured to output a magnetic field intensity; and
a processor configured to:
calibrate the magnetic sensor;
obtain multiple sets of measured intensity of a magnetic field output by a magnetic sensor on a movable platform during rotation of the movable platform after detecting that a magnetic sensor calibration condition is triggered, wherein the rotation includes at least a rotation in a horizontal plane;
determine a calibration coefficient of the magnetic sensor based on a reference magnetic field intensity of the magnetic sensor and the multiple sets of measured intensity, wherein the reference magnetic field intensity is an intensity of the magnetic field output by the magnetic sensor after a first time calibration or a last time calibration; and
calibrate the intensity of the magnetic field output by the magnetic sensor based on the calibration coefficient of the magnetic sensor.

12. The movable platform according to claim 11, wherein when detecting that the calibration condition of the magnetic sensor is triggered, the processor is further configured to:
detect that at least one flight parameter of the movable platform meets a preset magnetic sensor calibration condition; or
detect that the movable platform receives a magnetic sensor calibration instruction from a control terminal of the movable platform, wherein the magnetic sensor calibration instruction is determined by the control terminal based on a detected magnetic sensor calibration operation of a user; or
detect that a time period to calibrate the magnetic sensor is reached; or
detect that a difference between a modulus of the intensity of magnetic field output by the magnetic sensor and a predefined modulus is greater than a preset difference.

13. The movable platform according to claim 11, wherein each set of the multiple sets of measured intensity includes a pitch-axis magnetic field intensity and a yaw-axis magnetic field intensity; and
the calibration coefficient includes a magnetic intensity gain, a pitch-axis magnetic field intensity offset, and yaw-axis magnetic field intensity offset.

14. The movable platform of claim 13, wherein
each set of the multiple sets of measured intensity further includes a roll-axis magnetic field intensity; and
the calibration coefficient also includes a roll-axis magnetic field intensity offset.

15. The movable platform according to claim 11, wherein the reference magnetic field intensity includes a reference pitch-axis magnetic field intensity, a reference yaw-axis magnetic field intensity, and a reference roll-axis magnetic field intensity;
each set of the multiple sets of measured intensity includes a pitch-axis magnetic field intensity, a yaw-axis magnetic field intensity, and a roll-axis magnetic field intensity; and
the processor is further configured to determine the calibration coefficient of the magnetic sensor based on
that for each set of measured intensities, the pitch-axis magnetic field intensity, the yaw-axis magnetic field intensity, and the roll-axis magnetic field intensity respectively meet a corresponding preset criterion with the reference pitch-axis magnetic field intensity, the reference yaw-axis magnetic field intensity, and the reference roll-axis magnetic field intensity, and
a sum of squares of the pitch-axis magnetic field intensity, the yaw-axis magnetic field intensity, and the roll-axis magnetic field intensity is equal to a preset modulus.

16. The movable platform according to claim 15, wherein the preset criterion between the pitch-axis magnetic field intensity and the reference pitch-axis magnetic field intensity is a linear relationship;
the preset criterion between the yaw-axis magnetic field intensity and the reference yaw-axis magnetic field intensity is a linear relationship; and
the preset criterion between the roll-axis magnetic field intensity and the reference roll-axis magnetic field intensity is a linear relationship.

17. The movable platform according to claim 11, further comprising a gyroscope configured to obtain a number of rotations of the movable platform; and
the processor is further configured to: when the number of rotations is greater than or equal to a preset number of rotations, stop obtaining the measured intensity output by the magnetic sensor during the rotation of the movable platform.

18. The movable platform according to claim 17, further comprising:
a communications apparatus, configured to: after the processor determines the calibration coefficient of the magnetic sensor based on the reference magnetic field intensity and the multiple sets of measured intensity, send calibration completion information to a control terminal of the movable platform, wherein the calibration completion information indicates that a calibration process of the magnetic sensor is completed.

19. The movable platform according to claim 11, further comprising:
a communications apparatus, configured to: before the processor obtains the multiple sets of measured intensity output by the magnetic sensor on the movable platform during the rotation of the movable platform, receive a rotation control instruction sent by a control terminal of the movable platform; and
the processor is further configured to control the rotation of the movable platform according to the rotation control instruction.

20. The movable platform according to claim 11, wherein the processor is further configured to: after the magnetic sensor calibration condition is triggered, control the rotation of the movable platform before the obtaining of the multiple sets of measured intensity output by the magnetic sensor on the movable platform during the rotation of the movable platform.
